(19) United States
(12) Patent Application Publication
(10) Pub. No.: US 2024/0312051 A1
(43) Pub. Date: Sep. 19, 2024

(54) POINT CLOUD PROCESSING APPARATUS, POINT CLOUD PROCESSING METHOD, NON-TRANSITORY RECORDING MEDIUM, AND POINT CLOUD PROCESSING SYSTEM

(71) Applicants: Noriyuki SAI, Kanagawa (JP); Naoki MOTOHASHI, Kanagawa (JP)

(72) Inventors: Noriyuki SAI, Kanagawa (JP); Naoki MOTOHASHI, Kanagawa (JP)

(73) Assignee: Ricoh Company, Ltd., Tokyo (JP)

(21) Appl. No.: 18/593,079

(22) Filed: Mar. 1, 2024

(30) Foreign Application Priority Data
Mar. 17, 2023 (JP) 2023-042490

(51) Int. Cl. G06T 7/73; G06V 10/26

(52) U.S. Cl. CPC G06T 7/73; G06V 10/26; G06T 2207/10028; G06T 2207/20081

(57) ABSTRACT

A point cloud processing apparatus includes circuitry to identify, based on labeled training data, a predetermined three-dimensional point cloud corresponding to the labeled training data in a target point cloud being a three-dimensional point cloud and determine whether a specific point cloud being a specific three-dimensional point cloud is included in a point cloud being another three-dimensional point cloud obtained by excluding the predetermined three-dimensional point cloud from the target point cloud to obtain a determination result.

### CROSS-REFERENCE TO RELATED APPLICATIONS

This patent application is based on and claims priority pursuant to 35 U.S.C. § 119(a) to Japanese Patent Application No. 2023-042490, filed on Mar. 17, 2023, in the Japan Patent Office, the entire disclosure of which is hereby incorporated by reference herein.

### BACKGROUND

### Technical Field

Embodiments of the present disclosure relate to a point cloud processing apparatus, a point cloud processing method, a non-transitory recording medium, and a point cloud processing system.

### Related Art

In the related art, three-dimensional (3D) detection for a target object includes extracting feature information of point cloud data of an acquired scene; semantically segmenting the point cloud data to obtain first semantic information of multiple points in the point cloud data based on the feature information of the point cloud data; predicting at least one foreground point corresponding to the target object among the multiple points based on the first semantic information; generating an initial 3D frame corresponding to each of the at least one foreground point based on the first semantic information; and determining a 3D detection frame of the target object in the scene based on the initial 3D frame.

### SUMMARY

According to one or more embodiments of the disclosure, a point cloud processing apparatus includes circuitry to identify, based on labeled training data, a predetermined three-dimensional point cloud corresponding to the labeled training data in a target point cloud being a three-dimensional point cloud and determine whether a specific point cloud being a specific three-dimensional point cloud is included in a point cloud being another three-dimensional point cloud obtained by excluding the predetermined three-dimensional point cloud from the target point cloud to obtain a determination result.

According to one or more embodiments of the disclosure, a point cloud processing apparatus includes circuitry to identify, based on data on a category, a predetermined three-dimensional point cloud corresponding to the data on a category, in a target point cloud being a three-dimensional point cloud. The data on the category is designated in advance. The circuitry determines whether a specific point cloud being a specific three-dimensional point cloud is included in a point cloud being another three-dimensional point cloud obtained by excluding the predetermined three-dimensional point cloud from the target point cloud to obtain a determination result.

According to one or more embodiments of the disclosure, a point cloud processing system includes one of the above-described point cloud processing apparatuses and a terminal apparatus communicably connected to the one of the above-described point cloud processing apparatuses. The circuitry of the one of the above-described point cloud processing apparatuses transmits a determination result to the terminal apparatus. The terminal apparatus includes additional circuitry to receive the determination result transmitted from the point cloud processing apparatus and display, on a display, the determination result.

According to one or more embodiments of the disclosure, a non-transitory recording medium stores a plurality of instructions which, when executed by one or more processors, causes the processors to perform a method. The method includes identifying, based on labeled training data, a predetermined three-dimensional point cloud corresponding to the labeled training data in a target point cloud being a three-dimensional point cloud and determining whether a specific point cloud being a specific three-dimensional point cloud is included in a point cloud being another three-dimensional point cloud obtained by excluding the predetermined three-dimensional point cloud from the target point cloud.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of a point cloud processing system according to some embodiments of the present disclosure;

FIG. 2 is a block diagram illustrating a hardware configuration of each of a terminal apparatus and a management server according to some embodiments of the present disclosure;

FIG. 3 is a block diagram illustrating a functional configuration of a point cloud processing system according to some embodiments of the present disclosure; embodiments of the present disclosure;

FIG. 5 is a flowchart of point cloud processing according to some embodiments of the present disclosure;

FIG. 6 is a diagram illustrating a point cloud setting screen according to some embodiments of the present disclosure;

FIG. 7 is a diagram illustrating a target point cloud setting screen according to some embodiments of the present disclosure;

FIG. 8 is a diagram illustrating a labeled training data setting screen according to some embodiments of the present disclosure;

FIG. 9 is a diagram illustrating an operation screen according to some embodiments of the present disclosure; and

FIG. 10 is a diagram illustrating a determination result display screen according to some embodiments of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In the fields of civil engineering and architecture, the implementation of building information modeling (BIM)/construction information modeling (CIM) has been promoted for coping with, for example, the demographic shift towards an older population and enhancing labor efficiency and productivity.

BIM is a solution that involves utilizing a database of buildings, in which attribute data such as cost, finishing details, and management information, is added to a three-dimensional (3D) digital model of a building. This model is created on a computer and utilized throughout every stage of the architectural process, including design, construction, and maintenance. The three-dimensional digital model is referred to as a 3D model in the following description.

CIM is a solution that has been proposed for the field of civil engineering (covering general infrastructure such as roads, electricity, gas, water supply, etc.) following BIM that has been advancing in the field of architecture. CIM is being pursued, similar to BIM, to aim for efficiency and advancement in a series of construction production systems by sharing information through centralized 3D models among participants.

A matter of concern for promoting BIM/CIM implementation is how to easily obtain 3D information on spatial aspects of a building or a public facility. The “3D information” used in the following description refers to, for example, a three-dimensional point cloud retaining distance information of a space acquired by, for example, a laser scanner, a mesh object generated based on point cloud data representing a three-dimensional point cloud, or a 3D Computer Aided Design (3DCAD) model. In the following description, the three-dimensional point cloud may also be referred to as a point cloud, and the laser scanner is also referred to as an LS.

When a structure is constructed from the beginning, BIM/CIM software can be used to design a completed structure from the beginning, so that BIM/CIM can be easily introduced. On the other hand, regarding the existing buildings, there is a case where, for example, a design drawing at the time of construction does not remain, or a current situation is different from a drawing at the time of design due to modification with the lapse of time, and the barriers for the BIM/CIM implementation are high. Such BIM implementation for an existing building is called “As-Build BIM,” and is an issue for promoting the BIM/CIM implementation going forward.

As a way to achieve the As-Build BIM, a workflow of performing spatial measurement using the above-described LS and creating a 3DCAD model from point cloud data obtained by the spatial measurement. This task has been performed in the related art by using, for example, a method of measuring with photographs, a method of measuring manually, or a method of sketching by hand. However, in such an approach by using the known method described above, significant costs may arise due to factors such as a size of a space, the presence of an object in a space, or the complexity of a space (for example, complexity of pipe arrangement). As an effective way to address such an issue, the introduction of an LS that acquires 3D information on a space has been gaining attention.

In the Ad-Build using the LS, acquisition of the 3D information is facilitated, however, a work of point cloud processing performed on point cloud data, which has not been present in the known art, newly arises. In typical point cloud processing, for example, “multipoint measurement using LS,” “generation of a merged point cloud through alignment of individual point clouds,” “removal of unnecessary points (an unnecessary point cloud) such as noise,” “mesh conversion of a point cloud, texture-mapping to a mesh, and 3DCAD model conversion” are performed.

Further, techniques such as “3D object search” and “3D shape search” in which three-dimensional point cloud data to be searched and specific three-dimensional point cloud data to be used as a search key are prepared, and a portion having a shape (and a color in some cases) similar to that of the point cloud used as the search key is found from the point cloud to be searched are known. However, searching the entire three-dimensional point cloud data takes a long processing time.

Further, some techniques to perform segmentation on three-dimensional point cloud data using labeled training data are also known in the art.

The labeled training data is used for machine learning and includes correct answers corresponding to the respective sample problems. By repeatedly causing artificial intelligence (AI) to learn sample problems and the corresponding correct answers, segmentation of three-dimensional point cloud data can be performed.

However, in order to perform such segmentation, the labeled training data is to be prepared, and performing segmentation on a point cloud for which labeled training data is absent is difficult.

In view of the foregoing, an object of one or more aspects of the present disclosure is to increase the efficiency of search and to increase the search speed by performing segmentation on a point cloud other than the point cloud to be searched and excluding the point cloud on which the segmentation is performed from the search target.

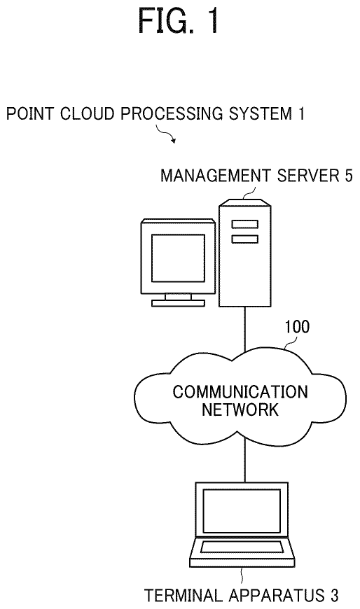

FIG. 1 is a diagram illustrating an overall configuration of a point cloud processing system according to an embodiment of the present disclosure. A point cloud processing system 1 according to the present embodiment includes a terminal apparatus 3 and a management server 5. The terminal apparatus 3 serves as an external device.

The management server 5 serves as a point cloud processing apparatus that performs point cloud processing including one or more point cloud processing operations on point cloud data representing a three-dimensional point cloud.

In the description of the present embodiment, the three-dimensional point cloud is defined as a collection of, or a set of coordinate points in some directions, for example, the X, Y, and Z directions that correspond to measurement points on the surface of an object when a certain space in which the object is present is measured using, for example, a laser scanner LS. For example, the coordinate points are indicated as (1,3,5). Further, color information may be added to each of the coordinate points, and, as the color information, an RGB value may be added to each of the coordinate points. The three-dimensional point cloud may also be referred to as a point cloud. The point cloud data is data that represents a collection of, or a set of coordinate points, which corresponds to a three-dimensional point cloud, in a virtual three-dimensional space, and that can be processed by, for example, a computer.

In the present embodiment, the three-dimensional point cloud is measured using the laser scanner LS. In some embodiments, another optical measurement means or a mechanical measurement means may be used. The optical measuring means includes a method using a stereo camera and a method using Visual Simultaneous Localization and Mapping (SLAM).

The terminal apparatus 3 and the management server 5 can communicate with each other via a communication network 100. The communication network 100 is implemented by, for example, the Internet, a mobile communication network, or a local area network (LAN). The communication network 100 may include, in addition to wired communication networks, wireless communication networks in compliance with, for example, 3rd generation (3G), Worldwide Interoperability for Microwave Access (WiMAX), or long term evolution (LTE). Further, the terminal apparatus 3 can establish communication using a short-range communication technology such as NEAR FIELD COMMUNICATION (NFC) (registered trademark).

### Hardware Configuration

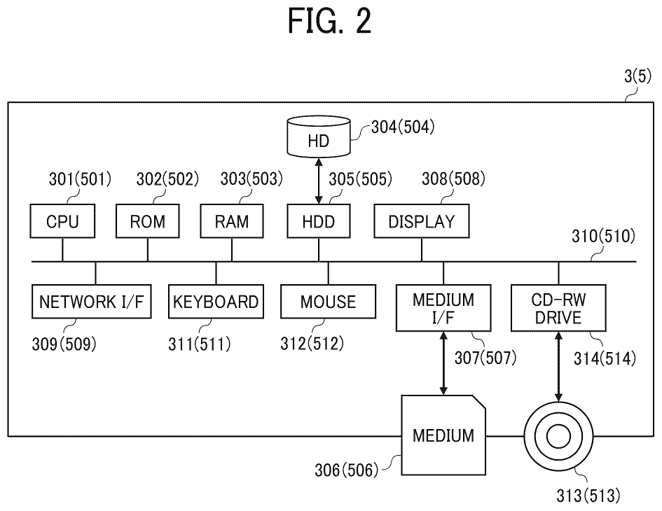

FIG. 2 is a block diagram illustrating a hardware configuration of each of a terminal apparatus and a management server according to the present embodiment. The hardware components of the terminal apparatus 3 are denoted by reference numerals in the 300 series. The hardware components of the management server 5 are denoted by reference numerals in the 500 series.

The terminal apparatus 3 includes a central processing unit (CPU) 301, a read only memory (ROM) 302, a random access memory (RAM) 303, a hard disk (HD) 304, a hard disk drive (HDD) 305, a medium interface (I/F) 307 that controls reading and writing of various data from and to a recording medium 306, a display 308, a network I/F 309, a keyboard 311, a mouse 312, a compact disc-rewritable (CD-RW) drive 314, and a bus line 310.

The CPU 301 performs overall control of the operation of the terminal apparatus 3. The ROM 302 stores a program for driving the CPU 301. The RAM 303 is used as a work area for the CPU 301. The HD 304 stores various data such as a program. The HDD 305 controls reading and writing of various data to and from the HD 304 under the control of the CPU 301. The medium I/F 307 controls reading and writing of various data from and to the recording medium 306. The display 308 displays various information such as a cursor, a menu, a window, a character, or an image. The network I/F 309 is an interface for data communication via the communication network 100. The keyboard 311 is an input device that is provided with multiple keys that allows a user to input characters, numerals, or various instructions. The mouse 312 is another input device that allows a user to select or execute a specific instruction, select an object to be processed, or move a cursor being displayed. The CD-RW drive 314 controls reading and writing of various data from and to the CD-RW 313 that serves as a removable storage medium. In some embodiments, the terminal apparatus 3 has a configuration that controls reading and writing (storing) of data with respect to an external personal computer (PC) or an external device connected via a wired connection or wireless connection such as WIFI.

The management server 5 includes a CPU 501, a ROM 502, a RAM 503, an HD 504, an HDD 505, a medium I/F 507 that controls reading and writing of various data from and to a recording medium 506, a display 508, a network I/F 509, a keyboard 511, a mouse 512, a CD-RW drive 514, and a bus line 510. The above-described components of the management server 5 are substantially the same as or similar to the above-described components (the CPU 301, the ROM 302, the RAM 303, the HD 304, the HDD 305, the recording medium 306, the medium I/F 307, the display 308, the network I/F 309, the keyboard 311, the mouse 312, the CD-RW drive 314, and the bus line 310) of the terminal apparatus 3. Accordingly, the redundant description is omitted.

In some embodiments, a compact disc-recordable (CD-R) drive is used in alternative to the CD-RW drive 314 (514). Each of the terminal apparatus 3 and the management server 5 may be implemented by a single computer or multiple computers to which divided units (functions, means, or storage units) are allocated as desired.

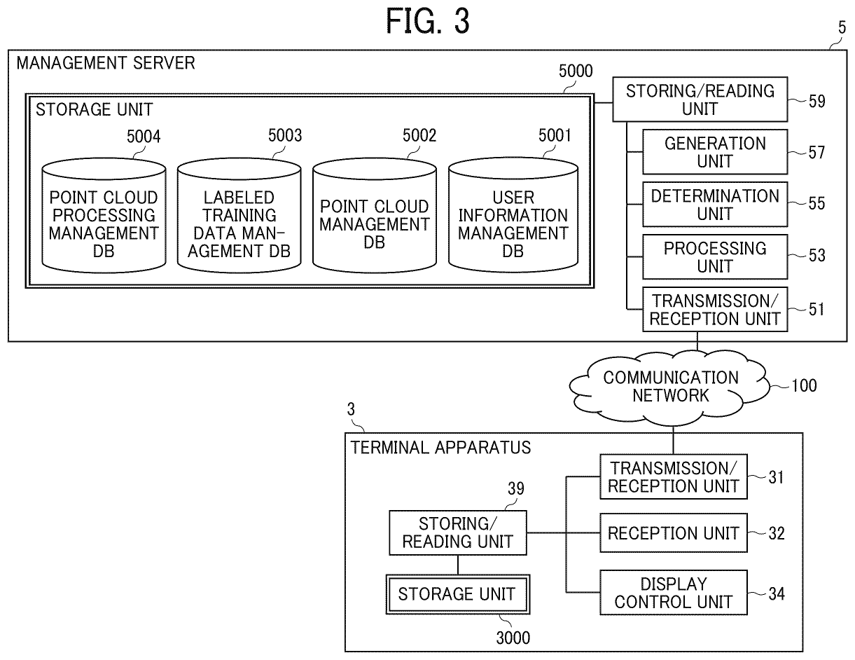

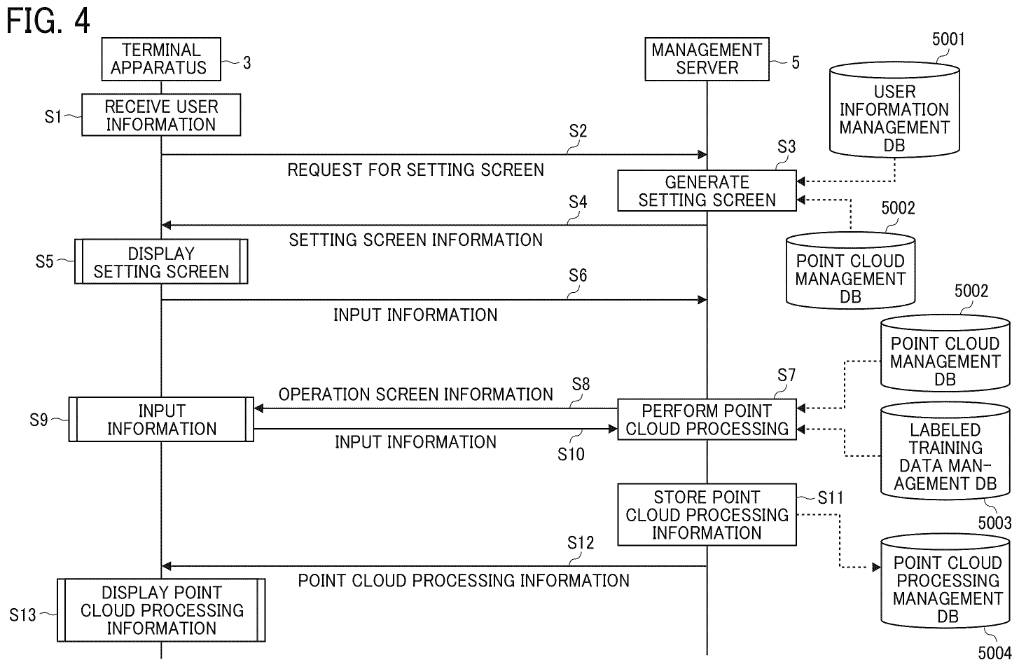

FIG. 3 is a block diagram illustrating a functional configuration of a point cloud processing system according to the present embodiment.

### Functional Configuration of Terminal Apparatus

As illustrated in FIG. 3, the terminal apparatus 3 includes a transmission/reception unit 31, a reception unit 32, a display control unit 34, and a storing/reading unit 39. The units are functions or devices implemented by operating one or more of the components illustrated in FIG. 2 in response to an instruction from the CPU 301 operating according to a program loaded from the HD 304 to the RAM 303. The terminal apparatus 3 further includes a storage unit 3000 implemented by the RAM 303 and the HD 304 illustrated in FIG. 2.

### Functional Units of Terminal Apparatus

Each functional unit of the terminal apparatus 3 is described below.

The transmission/reception unit 31, which serves as a receiving unit, is implemented by an instruction from the CPU 301 illustrated in FIG. 2 and the network I/F 309 illustrated in FIG. 2. The transmission/reception unit 31 transmits and receives various data (or information) to and from another terminal, device, apparatus, or system via the communication network 100.

The reception unit 32 serves as, for example, a receiving unit, and is implemented by the keyboard 311, and the mouse 312, which are illustrated in FIG. 2, and an instruction from the CPU 301 illustrated in FIG. 2. The reception unit 32 receives various inputs from a user.

The display control unit 34 serves as a display control means and is implemented by an instruction from the CPU 301 illustrated in FIG. 2. The display control unit 33 controls the display 308 serving as a display unit to display various images and screens.

The storing/reading unit 39 serves as, for example, a storage control unit, and implemented by the HDD 305, the medium I/F 307, the CD-RW drive 314, which are illustrated in FIG. 2, in addition to an instruction from the CPU 301 of FIG. 2. The storing/reading unit 39 stores various data in the storage unit 3000, the recording medium 306, or the CD-RW 313 and reads the various data from the storage unit 3000, the recording medium 306, or the CD-RW 313.

### Functional Configuration of Management Server

The management server 5 includes a transmission/reception unit 51, a processing unit 53, a determination unit 55, a generation unit 57, and a storing/reading unit 59. Each of the above-mentioned units is a function that is implemented by or that is caused to function by operating one or more of the components illustrated in FIG. 2 according to an instruction from the CPU 501 according to a program loaded from the HD 504 to the RAM 503. The management server 5 further includes a storage unit 5000 implemented by the HD 504 illustrated in FIG. 2. The storage unit 5000 serves as a storing unit.

### Functional Units of Management Server

Each functional unit of the management server 5 is described below. The management server 5 may be implemented by multiple computers in manner that some or all of the functions are distributed to the multiple computers. Although the management server 5 is a server computer that resides in a cloud environment in the following description, alternatively, the management server 5 may be a server that resides in an on-premises environment.

The transmission/reception unit 51 serves as, for example, a transmission unit and is implemented by an instruction from the CPU 501 and the network I/F 509, which are illustrated in FIG. 2. The transmission/reception unit 51 transmits and receives various data (or information) to and from another terminal, device, apparatus, or system via the communication network 100.

The processing unit 53 is implemented by an instruction from the CPU 501 illustrated in FIG. 2 and performs various processes, which are described later. The processing unit 53 serves as a point cloud processing unit.

The determination unit 55 is implemented by an instruction from the CPU 501 illustrated in FIG. 2 and performs various determinations, which are described later.

The generation unit 57 is implemented by an instruction from the CPU 501 illustrated in FIG. 2 and performs various types of generation such as screen generation, which is described later.

The storing/reading unit 59 serves as a storage control unit, and implemented by the HDD 505, the medium I/F 507, the CD-RW drive 514, which are illustrated in FIG. 2, in addition to an instruction from the CPU 501 illustrated in FIG. 2. The storing/reading unit 59 stores various data in the storage unit 5000, the recording medium 506, or the CD-RW 513 and reads the various data from the storage unit 5000, the recording medium 506, or the CD-RW 513. Each of the storage unit 5000, the recording medium 506, the CD-RW 513, the external PC, and the external device serves as a storing unit.

The storage unit 5000 includes a user information management database (DB) 5001, a point cloud management DB 5002, a labeled training data management DB 5003, and a point cloud processing management DB 5004 that are implemented by a setting information management table.

In the user information management DB 5001, a file name of three-dimensional point cloud data is stored and managed in association with user information. In the labeled training data management DB 5003, labeled training data for identifying a predetermined three-dimensional point cloud is stored and managed. In the point cloud management DB 5002, point cloud data is stored and managed. In the point cloud processing management DB 5004, processing result information indicating a processing result of point cloud processing performed on point cloud data is stored and managed.

As described above, the labeled training data is data with corresponding correct answers provided for sample problems, and in the labeled training data management DB 5003, for example, multiple pairs of labeling “desk” as a correct answer and “point cloud” as a sample problem are stored and managed.

FIG. 4 is a sequence diagram illustrating point cloud processing according to the present embodiment. The sequence diagram illustrated in FIG. 4 includes an identification step of identifying a predetermined three-dimensional point cloud corresponding to labeled training data in a target point cloud being a three-dimensional point cloud in a target range based on the labeled training data, and a determination step of determining whether a specific point cloud being a specific three-dimensional point cloud that does not correspond to the labeled training data is included in an excluded point cloud being a three-dimensional point cloud obtained by excluding the predetermined three-dimensional point cloud identified by an identification unit from the target point cloud.

The reception unit 32 of the terminal apparatus 3 receives an input operation related to user information (Step S1). The transmission/reception unit 31 of the terminal apparatus 3 transmits to the management server 5 a request for a setting screen along with the user information received in Step S1, and the transmission/reception unit 51 of the management server 5 receives the request including the user information transmitted from the terminal apparatus 3 (Step S2).

Subsequently, the storing/reading unit 59 of the management server 5 searches the user information management DB 5001 using the user information included in the request received in Step S2 as a search key to read a file name of three-dimensional point cloud data and labeled training data that are associated with the user information included in the request, and searches the point cloud management DB 5002 using the read file name as a search key to read three-dimensional point cloud data corresponding to the file name.

The generation unit 57 of the management server 5 generates a display screen including a setting screen based on the file name, the three-dimensional point cloud data, and the labeled training data name that has been read by the storing/reading unit 59 (Step S3).

The transmission/reception unit 51 transmits to the terminal apparatus 3 display screen information including setting screen information related to the setting screen generated in Step S3, and the transmission/reception unit 31 of the terminal apparatus 3 receives the display screen information transmitted from the management server 5 (Step S4).

Subsequently, the display control unit 34 of the terminal apparatus 3 displays on the display 308 the display screen including the setting screen received in Step S4 (Step S5). The reception unit 32 of the terminal apparatus 3 receives an input operation performed by the user on the setting screen currently displayed. The input operation includes a point cloud designation operation for designating one or more three-dimensional point clouds as one or more target point clouds, a point cloud specifying operation for specifying one or more three-dimensional point clouds as one or more specific point clouds, and a data designation operation for designating one or more categories, for example, such as “Floor” and “Wall,” as one or more types of labeled training data.

The transmission/reception unit 31 transmits input information related to the input operation received by the reception unit 32 to the management server 5, and the transmission/reception unit 51 of the management server 5 receives the input information transmitted from the terminal apparatus 3 (Step S6). The input information includes point cloud designation information for designating one or more three-dimensional point clouds as one or more target point clouds, a point cloud specifying information for specifying one or more three-dimensional point clouds as one or more specific point clouds, and a data designation information for designating one or more types of labeled training data.

The storing/reading unit 59 of the management server 5 searches the point cloud management DB 5002 using the point cloud designation information and the point cloud specifying information that are included in the input information received in Step S6 as a search key to read three-dimensional point cloud data representing a target point cloud corresponding to the point cloud designation information and three-dimensional point cloud data representing a specific point cloud corresponding to the point cloud specifying information.

Further, the storing/reading unit 59 searches the labeled training data management DB 5003 using the data designation information included in the input information received in Step S6 as a search key to read labeled training data corresponding to the data designation information.

The processing unit 53 and the determination unit 55 of the management server 5 generates point cloud processing information based on the three-dimensional point cloud data representing the target point cloud, the three-dimensional point cloud being a specific point cloud, and the labeled training data that are read by the storing/reading unit 59 (Step S7). The point cloud processing information includes a determination result of whether the specific point cloud is included in the target point cloud and the position of the specific point cloud in the target point cloud.

Specifically, the processing unit 53 identifies a predetermined three-dimensional point cloud corresponding to the labeled training data in the specific point cloud based on the labeled training data.

When the determination unit 55 does not determine that the predetermined three-dimensional point cloud is identified, the processing unit 53 performs processing of identifying a predetermined three-dimensional point cloud corresponding to the labeled training data in the target point cloud based on the labeled training data designated by the data designation information received in Step S6. The determination unit 55 determines whether the specific point cloud is included in an excluded point cloud obtained by excluding a predetermined three-dimensional point cloud identified based on the labeled training data from the target point cloud, and determines, when the specific point cloud is included, the position of the specific point cloud in the target point cloud.

On the other hand, when the determination unit 55 determines that the predetermined three-dimensional point cloud has been identified, the generation unit 57 generates an operation screen including the identification result, and the transmission/reception unit 51 transmits display screen information including operation screen information indicating the operation screen to the terminal apparatus 3 (Step S8).

The transmission/reception unit 31 of the terminal apparatus 3 receives the display screen information including the operation screen information transmitted from the management server 5, the display control unit 34 of the terminal apparatus 3 displays on the display 308 the display screen including the received operation screen, and the reception unit 32 of the terminal apparatus 3 receives an input operation performed by the user on the operation screen currently displayed (Step S9). The input operation includes a reconfiguration instruction operation for instructing to reconfigure the labeled training data.

The transmission/reception unit 31 transmits input information related to the input operation received by the reception unit 32 to the management server 5, and the transmission/reception unit 51 of the management server 5 receives the input information transmitted from the terminal apparatus 3 (Step S10).

When the input information includes reconfiguration instruction information by the reconfiguration instruction operation, the storing/reading unit 59 searches the labeled training data management DB 5003 using the reconfiguration instruction information as a search key to read labeled training data corresponding to the data designation information.

The processing unit 53 performs processing of identifying a predetermined three-dimensional point cloud corresponding to the labeled training data in the target point cloud based on the labeled training data designated by the reconfiguration instruction information received in Step S10. The determination unit 55 determines whether the specific point cloud is included in an excluded point cloud obtained by excluding a predetermined three-dimensional point cloud identified based on the labeled training data from the target point cloud, and determines, when the specific point cloud is included, the position of the specific point cloud in the target point cloud.

The processing unit 53 converts the point cloud processing information including the determination result into, for example, a file format readable by the point cloud processing software, a file format readable by the 3DCAD software, or a file format readable by the BIM/CIM software, and the storing/reading unit 59 stores the converted point cloud processing information in the point cloud processing management DB 5004, the recording medium 506, or the CD-RW 513 (Step S11).

The transmission/reception unit 51 transmits the point cloud processing information to the terminal apparatus 3 (Step S12). The transmission/reception unit 31 of the terminal apparatus 3 receives the point cloud processing information transmitted from the management server 5, and the display control unit 34 of the terminal apparatus 3 displays the received point cloud processing information on the display 308 (Step S13).

In some embodiments, the functional units of the management server 5 in FIG. 3 are integrated into the terminal apparatus 3, and the processing of the management server 5 described with reference to FIG. 4 is also executed by the terminal apparatus 3.

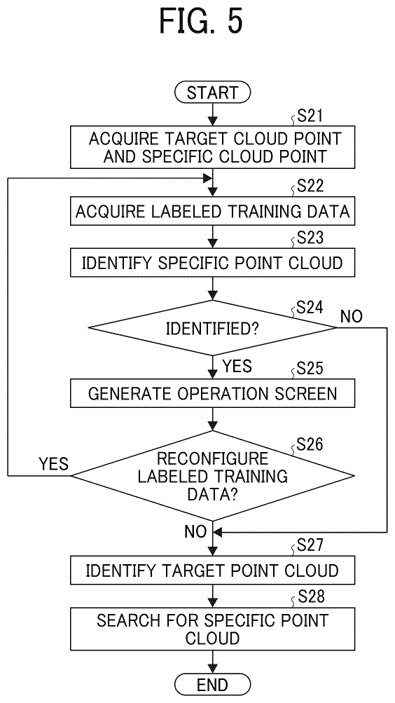

FIG. 5 is a flowchart of performing point cloud processing according to the present embodiment, and corresponds to the processing of Step S7 in FIG. 4.

The storing/reading unit 59 of the management server 5 acquires the three-dimensional point cloud data corresponding to the point cloud designation information received in Step S6 and the three-dimensional point cloud data corresponding to the point cloud specifying information received in Step 6 from the point cloud management DB 5002 (Step S21), and acquires the labeled training data corresponding to the data designation information received in Step S6 from the labeled training data management DB 5003 (Step S22).

The processing unit 53 executes processing of identifying a predetermined three-dimensional point cloud corresponding to the labeled training data in the specific point cloud acquired in Step S22 based on the labeled training data acquired in Step S21 (Step S23).

The determination unit 55 determines whether a predetermined three-dimensional point cloud is identified in Step S23, and the process proceeds to Step S27 in when the predetermined three-dimensional point cloud is not identified (Step S24).

When the three-dimensional point cloud is identified in Step S24, the generation unit 57 generates an operation screen including the identification result in Step S24 (Step S25), and as illustrated in S8 and 10 of FIG. 4, the transmission/reception unit 51 transmits operation screen information to the terminal apparatus 3 and receives input information for the operation screen information.

The determination unit 55 determines whether the input information received in Step S10 of FIG. 4 includes the reconfiguration instruction information for reconfiguring the labeled training data, and when the input information includes the reconfiguration instruction information, the process returns to Step S22, and the labeled training data corresponding to the reconfiguration instruction information is acquired (Step S26).

When the reconfiguration instruction information is not included in Step S26, the processing unit 53 executes processing of identifying a predetermined three-dimensional point cloud corresponding to the labeled training data in the target point cloud acquired in Step S22 based on the labeled training data acquired in Step S21 (Step S27).

Subsequently, the determination unit 55 searches whether the specific point cloud acquired in Step S21 is included in an excluded point cloud obtained by excluding the predetermined three-dimensional point cloud identified in Step S27 from the target point cloud acquired in Step S21 (Step S28).

Specifically, the determination unit 55 determines whether the specific point cloud acquired in Step S21 is included in the excluded point cloud obtained by excluding the predetermined three-dimensional point cloud identified in Step S27 from the target point cloud acquired in Step S21, and determines, when the specific point cloud is included, the position of the specific point cloud in the target point cloud.

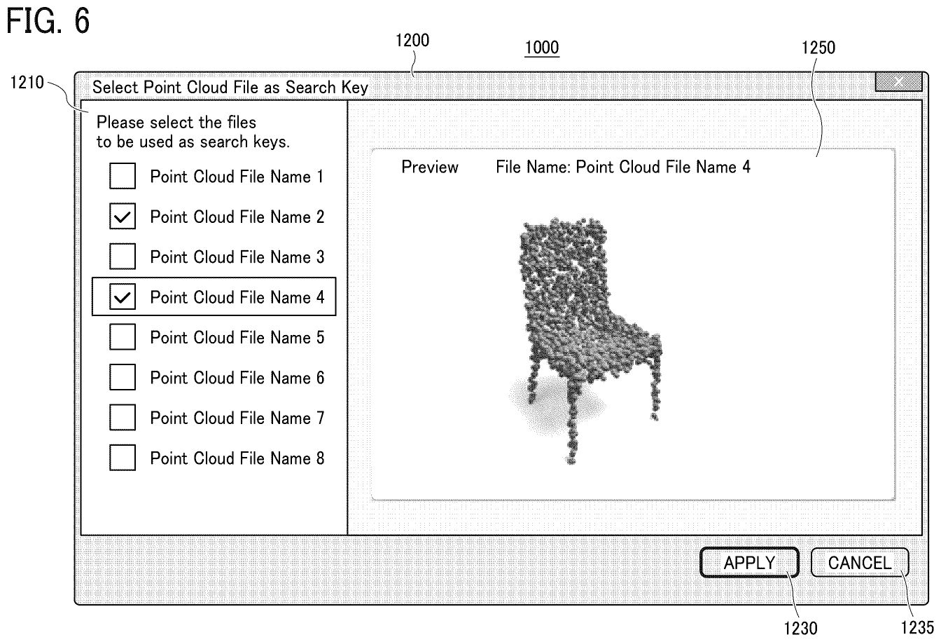

FIG. 6 is a diagram illustrating a point cloud setting screen according to the present embodiment. In FIG. 6, a display screen 1000 that is displayed on the display 308 of the terminal apparatus 3 in Step S5 of the sequence diagram illustrated in FIG. 4 is illustrated.

The display screen 1000 illustrated in FIG. 6 includes a specific point cloud setting screen 1200, and the specific point cloud setting screen 1200 includes a specific point cloud reception screen 1210, a specific point cloud display screen 1250, the setting button 1230, and a cancel button 1235.

The specific point cloud reception screen 1210 is a screen for receiving a point cloud specifying operation for specifying one or more three-dimensional point clouds, and displays the file name read in Step S3 of the sequence diagram illustrated in FIG. 4 in a selectable manner, and the user can select the file name by marking that is the point cloud specifying operation. The specific point cloud display screen 1250 is a screen for displaying a point cloud having a file name selected on the specific point cloud reception screen 1210.

In other words, the reception unit 32 receives a point cloud specifying operation for specifying one or more three-dimensional point clouds on the specific point cloud reception screen 1210, and one or more point cloud file names are specified based on the point cloud specifying operation received on the specific point cloud reception screen 1210. In the example of FIG. 6, point cloud file names 2 and 4 are specified as the specific point clouds.

Then, in the example of FIG. 6, the transmission/reception unit 31 transmits the point cloud file names 2 and 4 as the point cloud specifying information to the management server 5 when the reception unit 32 receives a user operation performed on the setting button 1230.

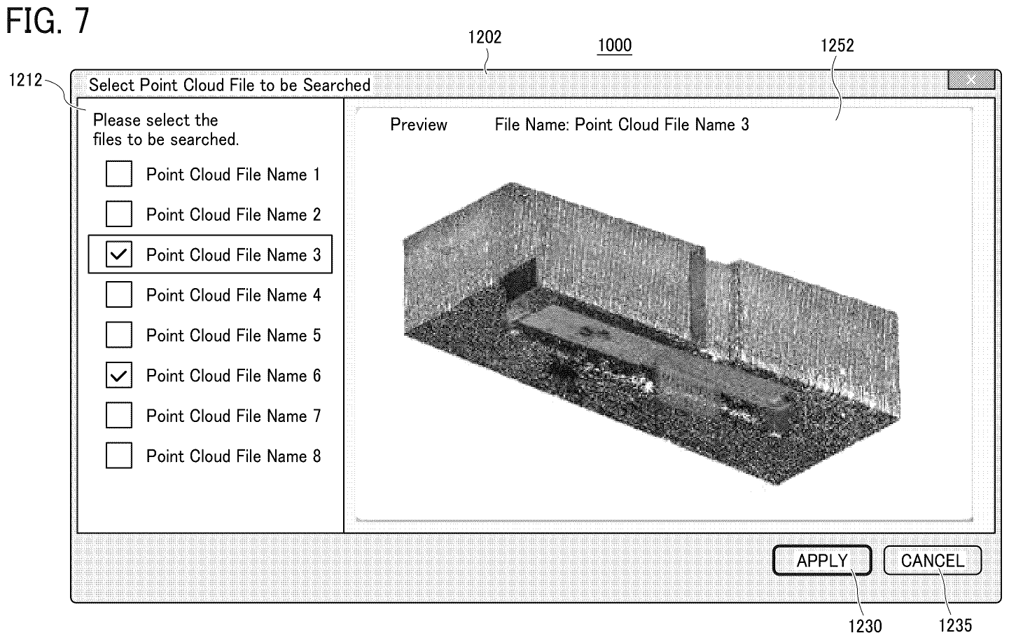

FIG. 7 is a diagram illustrating a target point cloud setting screen according to the present embodiment. FIG. 7 illustrates the display screen 1000 displayed on the display 308 of the terminal apparatus 3 in Step S5 of the sequence diagram illustrated in FIG. 4, and the display screen 1000 illustrated in FIG. 6 and the display screen 1000 illustrated in FIG. 7 are displayed by being switched.

The display screen 1000 illustrated in FIG. 7 includes a target point cloud setting screen 1202, and the target point cloud setting screen 1202 includes a target point cloud reception screen 1212, a target point cloud display screen 1252, the setting button 1230, and the cancel button 1235.

The target point cloud reception screen 1212 is a screen for receiving a point cloud designation operation for designating one or more three-dimensional point clouds, and displays the file name read in Step S3 of the sequence diagram illustrated in FIG. 4 in a selectable manner to allow the user to select the file name by marking that is the point cloud designation operation. The target point cloud display screen 1252 is a screen for displaying a point cloud having a file name selected on the target point cloud reception screen 1212.

In other words, the reception unit 32 receives a point cloud designation operation for designating one or more three-dimensional point clouds on the target point cloud reception screen 1212, and one or more point cloud file names are designated based on the point cloud designation operation received on the target point cloud reception screen 1212. In the example of FIG. 7, point cloud file names 3 and 6 are designated as the target point clouds.

Then, when the reception unit 32 receives a user operation on the setting button 1230, the transmission/reception unit 31 transmits the point cloud file names 3 and 6 as the point cloud designation information to the management server 5 in the example of FIG. 7.

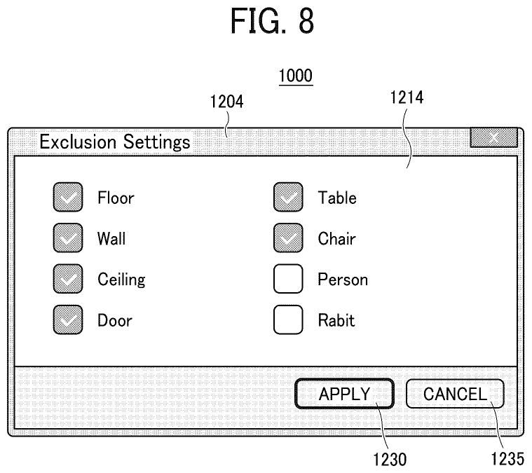

FIG. 8 is a diagram illustrating a labeled training data setting screen according to the present embodiment. FIG. 8 illustrates the display screen 1000 displayed on the display 308 of the terminal apparatus 3 in Step S5 of the sequence diagram illustrated in FIG. 4, and the display screen 1000 illustrated in FIG. 6, the display screen 1000 illustrated in FIG. 7, and the display screen 1000 illustrated in FIG. 8 are displayed by being switched.

The display screen 1000 illustrated in FIG. 8 includes a labeled training data setting screen 1204, and the labeled training data setting screen 1204 includes a data reception screen 1214, the setting button 1230, and the cancel button 1235.

The data reception screen 1214 is a screen for receiving a data designation operation for designating one or more types of labeled training data to be excluded, and displays the labeled training data names read in Step S3 of the sequence diagram illustrated in FIG. 4 in a selectable manner to allow the user to select a labeled training data name. A type of labeled training data corresponds to a category. A type of labeled training data is, for example, labeled training data categorized as floor, and the type of labeled training data may include multiple pieces of labeled training data, for example, data of various shapes of floors.

In other words, the reception unit 32 receives a data designation operation for designating one or more types of labeled training data on the data reception screen 1214, and in the example of FIG. 8, Floor, Wall, Ceiling, Door, Table, and Chair are designated as the labeled training data to be excluded, based on the data designation operation received on the data reception screen 1214.

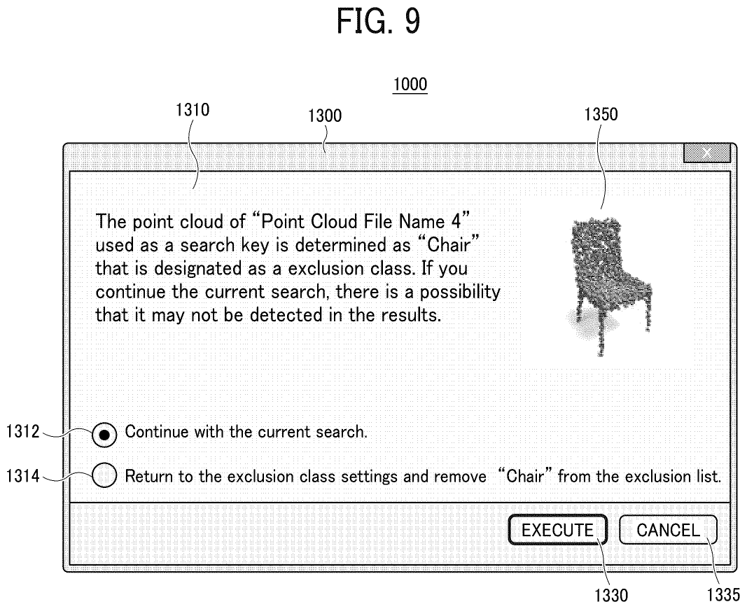

Then, when the reception unit 32 receives a user operation on the setting button 1230, the transmission/reception unit 31 transmits Floor, Wall, Ceiling, Door, Table, and Chair as the data designation information to the management server 5 in the example of FIG. 9.

FIG. 9 is a diagram illustrating an operation screen according to the present embodiment. FIG. 9 illustrates the display screen 1000 displayed on the display 308 of the terminal apparatus 3 in Step S10 of the sequence diagram illustrated in FIG. 4.

The display screen 1000 illustrated in FIG. 9 includes an operation screen 1300, and the operation screen 1300 includes an identification result display screen 1310, an execution button 1330, and a cancel button 1335. The identification result display screen 1310 further includes a process continuation instruction button 1312 and a reconfiguration instruction button 1314.

The identification result display screen 1310 displays the identification result in Step S24 of FIG. 5. In the example of FIG. 9, the identification result indicating that a point cloud corresponding to Chair of the labeled training data is identified in the point cloud of the point cloud file name 4 that is the specific point cloud is displayed.

The process continuation instruction button 1312 is for receiving a process continuation instruction operation for instructing continuation of the process without reconfiguring the labeled training data. When the reception unit 32 receives a user operation on the process continuation instruction button 1312 and the execution button 1330, the transmission/reception unit 31 transmits process continuation instruction information for instructing continuation of the process to the management server 5.

The reconfiguration instruction button 1314 is for receiving a reconfiguration instruction operation for instructing reconfiguring the labeled training data. When the reception unit 32 receives a user operation on the reconfiguration instruction button 1314 and the execution button 1330, the transmission/reception unit 31 transmits reconfiguration instruction information for instructing reconfiguring the labeled training data to the management server 5.

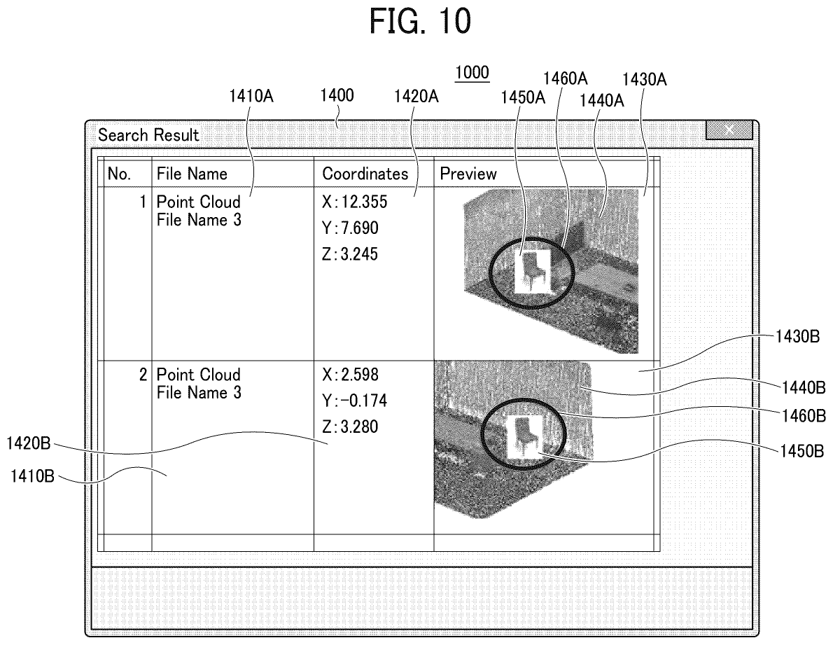

FIG. 10 is a diagram illustrating a determination result display screen according to the present embodiment. FIG. 10 illustrates the display screen 1000 displayed on the display 308 of the terminal apparatus 3 in Step S13 of the sequence diagram illustrated in FIG. 4.

The display screen 1000 illustrated in FIG. 10 includes a determination result display screen 1400, and the determination result display screen 1400 includes target point cloud name display screens 1410A and 1410B, specific point cloud position display screens 1420A and 1420B, and target point cloud display screens 1430A and 1430B.

Each of the target point cloud name display screens 1410A and 1410B displays a file name of the target point cloud, and each of the specific point cloud position display screens 1420A and 1420B displays a position of a specific point cloud in the target point cloud in XYZ-coordinates.

The target point cloud display screen 1430A displays a target point cloud 1440A and a specific point cloud identification image 1460A indicating the position of a specific point cloud 1450A in the target point cloud 1440A in a superimposed manner. Further, the target point cloud display screen 1430B displays a target point cloud 1440B and a specific point cloud identification image 1460B indicating the position of a specific point cloud 1450B in the target point cloud 1440B in a superimposed manner.

### Aspect 1

As described above, the management server 5 serving as a point cloud processing apparatus according to one or more embodiments of the present disclosure includes the processing unit 53 serving as an identifying unit that identifies, based on labeled training data, a predetermined three-dimensional point cloud corresponding to the labeled training data in a target point cloud being a three-dimensional point cloud, and the determination unit 55 that determines whether a specific point cloud being a specific three-dimensional point cloud is included in an excluded point cloud being a three-dimensional point cloud obtained by excluding the predetermined three-dimensional point cloud identified by the identifying unit from the target point cloud.

### Aspect 2

The management server 5 according to one or more embodiments of the present disclosure includes the processing unit 53 that identifies, based on data on one or more categories, a predetermined three-dimensional point cloud corresponding to the data on the one or more categories in a target point cloud being a three-dimensional point cloud, and the determination unit 55 that determines whether a specific point cloud being a specific three-dimensional point cloud is included in an excluded point cloud being a three-dimensional point cloud obtained by excluding the predetermined three-dimensional point cloud identified by the identifying unit from the target point cloud. The data on one or more categories is designated in advance.

Accordingly, whether the specific point cloud is included in the target point cloud can be easily determined.

In other words, determining whether the specific point cloud is included in the excluded point cloud obtained by excluding the predetermined three-dimensional point cloud from the target point cloud, is easier than determining whether the specific point cloud is included in the entire target point cloud.

### Aspect 3

In Aspect 1 or Aspect 2, the determination unit 55 further determines the position of the specific point cloud in the target point cloud.

Accordingly, the position of the specific point cloud that does not correspond to the labeled training data in the target point cloud can be easily determined.

### Aspect 4

In any one of Aspects 1 to 3, the management server 5 further includes a transmission/reception unit 51 serving as a transmission unit that transmits a determination result of the determination unit 55 to the terminal apparatus 3 serving as an external apparatus.

Accordingly, the determination result indicating whether the specific point cloud that does not correspond to the labeled training data is included in the target point cloud and a determination result for the position of the specific point cloud that does not correspond to the labeled training data in the target point cloud can be checked by the terminal apparatus 3.

### Aspect 5

In any one of Aspects 1 to 3, the terminal apparatus 3 in which the function of the management server 5 serving as a point cloud processing apparatus is integrated includes the display control unit 34 that causes the display 308 to display the determination result of the determination unit 55.

Accordingly, the determination result indicating whether the specific point cloud that does not correspond to the labeled training data is included in the target point cloud and a determination result for the position of the specific point cloud that does not correspond to the labeled training data in the target point cloud can be checked by being displayed on the display 308.

### Aspect 6

In any one of Aspects 1 to 5, the target point cloud is set based on a point cloud designation operation received on the target point cloud reception screen 1212 that receives a point cloud designation operation for designating one or more three-dimensional point clouds.

### Aspect 7

In any one of Aspects 1 to 6, the specific point cloud is set based on a point cloud specifying operation received on the specific point cloud reception screen 1210 that receives the point cloud specifying operation for specifying one or more three-dimensional point clouds.

Accordingly, whether the specific point cloud set based on the point cloud designation operation is included in the target point cloud designated based on the point cloud designation operation can be easily determined.

### Aspect 8

In any one of Aspects 1 to 7, the identifying unit identifies the predetermined three-dimensional point cloud corresponding to one of one or more types of labeled training data, based on a data designation operation received on the data reception screen 1214 for receiving the data designation operation for designating the one or more types of labeled training data.

Accordingly, whether the specific point cloud is included in the excluded point cloud obtained by excluding the predetermined three-dimensional point cloud designated based on the data designation operation from the target point cloud can be determined.

### Aspect 9

In any one of Aspects 1 to 8, the processing unit 53 also functions as a second identifying unit that identifies the predetermined three-dimensional point cloud in the specific point cloud based on the labeled training data.

Accordingly, whether a predetermined three-dimensional point cloud to be excluded is included in the specific point cloud can be checked.

### Aspect 10

In Aspect 9, the management server 5 includes the transmission/reception unit 51 that transmits a determination result of the second identifying unit to the terminal apparatus 3.

Accordingly, the terminal apparatus 3 can check whether the specific point cloud includes the predetermined three-dimensional point cloud to be excluded.

### Aspect 11

In Aspect 9, the terminal apparatus 3 in which the function of the management server 5 is integrated includes the display control unit 34 that causes the display 308 to display an identification result of the second identifying unit.

Accordingly, whether the predetermined three-dimensional point cloud to be excluded is included in the specific point cloud can be displayed on the display 308 and checked.

### Aspect 12

In a point cloud processing method according to one or more embodiments of the disclosure, an identification step and a determination step are executed by a computer. The identification step identifies, based on labeled training data, a predetermined three-dimensional point cloud corresponding to the labeled training data in a target point cloud being a three-dimensional point cloud. The determination step determines whether a specific point cloud being a specific three-dimensional point cloud is included in an excluded point cloud being a three-dimensional point cloud obtained by excluding the predetermined three-dimensional point cloud identified by an identification unit from the target point cloud.

### Aspect 13

In a point cloud processing method according to one or more embodiments of the disclosure, an identification step and a determination step are executed by a computer. The identification step identifies, based on designated data on one or more categories, a predetermined three-dimensional point cloud corresponding to the designated data on one or more categories in a target point cloud being a three-dimensional point cloud. The determination step determines whether a specific point cloud being a specific three-dimensional point cloud is included in an excluded point cloud being a three-dimensional point cloud obtained by excluding the predetermined three-dimensional point cloud identified by an identification unit from the target point cloud.

### Aspect 14

A program according to one or more embodiments of the present disclosure causes a computer to execute the point cloud processing method of Aspect 12 or Aspect 13.

### Aspect 15

The point cloud processing system 1 according to one or more embodiments of the present disclosure includes the management server 5 and the terminal apparatus 3 communicably connected to the management server 5. The management server 5 includes the processing unit 53 that identifies, based on labeled training data, a predetermined three-dimensional point cloud corresponding to the labeled training data in a target point cloud being a three-dimensional point cloud, the determination unit 55 that determines whether a specific point cloud being a specific three-dimensional point cloud is included in an excluded point cloud being a three-dimensional point cloud obtained by excluding the predetermined three-dimensional point cloud identified by the identifying unit from the target point cloud, and the transmission/reception unit 51 that transmits a determination result of the determination unit 55 to the terminal apparatus 3. The terminal apparatus 3 includes the transmission/reception unit 31 serving as a reception unit that receives the determination result transmitted from the management server 5 and the display control unit 34 that causes the display 308 to display the determination result.

### Aspect 16

The point cloud processing system 1 according to one or more embodiments of the present disclosure includes the management server 5 and the terminal apparatus 3 communicably connected to the management server 5. The management server 5 includes the processing unit 53 that identifies, based on designated data on one or more categories, a predetermined three-dimensional point cloud corresponding to the designated data on one or more categories in a target point cloud being a three-dimensional point cloud, the determination unit 55 that determines whether a specific point cloud being a specific three-dimensional point cloud is included in an excluded point cloud being a three-dimensional point cloud obtained by excluding the predetermined three-dimensional point cloud identified by the identifying unit from the target point cloud, and the transmission/reception unit 51 that transmits a determination result of the determination unit 55 to the terminal apparatus 3. The terminal apparatus 3 includes the transmission/reception unit 31 serving as a reception unit that receives the determination result transmitted from the management server 5 and the display control unit 34 that causes the display 308 to display the determination result.

According to one or more aspects of the present disclosure, whether a specific three-dimensional point cloud is included in a target point cloud is efficiently determined.

According to one or more aspects of the present disclosure, whether a specific three-dimensional point cloud is included in a target point cloud is efficiently determined.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. A point cloud processing apparatus, comprising circuitry configured to:
identify, based on labeled training data, a predetermined three-dimensional point cloud corresponding to the labeled training data in a target point cloud being a three-dimensional point cloud; and
determine whether a specific point cloud being a specific three-dimensional point cloud is included in a point cloud being another three-dimensional point cloud obtained by excluding the predetermined three-dimensional point cloud from the target point cloud, to obtain a determination result.

2. A point cloud processing apparatus, comprising circuitry configured to:
identify, based on data on a category, a predetermined three-dimensional point cloud corresponding to the data on the category in a target point cloud being a three-dimensional point cloud, the data on the category being designated in advance; and
determine whether a specific point cloud being a specific three-dimensional point cloud is included in a point cloud being another three-dimensional point cloud obtained by excluding the predetermined three-dimensional point cloud from the target point cloud, to obtain a determination result.

3. The point cloud processing apparatus of claim 1, wherein
the circuitry is further configured to determine a position of the specific point cloud in the target point cloud.

4. The point cloud processing apparatus of claim 2, wherein
the circuitry is further configured to determine a position of the specific point cloud in the target point cloud.

5. The point cloud processing apparatus of claim 1, wherein
the circuitry is further configured to transmit, to an external apparatus, the determination result.

6. The point cloud processing apparatus of claim 2, wherein
the circuitry is further configured to transmit, to an external apparatus, the determination result.

7. The point cloud processing apparatus of claim 1, wherein
the circuitry is further configured to display, on a display, the determination result.

8. The point cloud processing apparatus of claim 1, wherein
the target point cloud is set based on an operation received on a screen that receives the operation, the operation being for designating one or more three-dimensional point clouds.

9. The point cloud processing apparatus of claim 2, wherein
the target point cloud is set based on an operation received on a screen that receives the operation, the operation being for designating one or more three-dimensional point clouds.

10. The point cloud processing apparatus of claim 1, wherein
the specific point cloud is set based on an operation received on a screen that receives the operation, the operation being for designating one or more three-dimensional point clouds.

11. The point cloud processing apparatus of claim 2, wherein
the specific point cloud is set based on an operation received on a screen that receives the operation, the operation being for designating one or more three-dimensional point clouds.

12. The point cloud processing apparatus of claim 1, wherein
the labeled training data includes one or more types of labeled training data,
the circuitry is configured to identify the predetermined three-dimensional point cloud corresponding to one of the one or more types of labeled training data, based on a data designation operation received on a data reception screen for receiving the data designation operation, the data designation operation being for designating the one or more types of labeled training data.

13. The point cloud processing apparatus of claim 2, wherein
the category includes one or more types of categories, and
the circuitry is configured to identify the predetermined three-dimensional point cloud corresponding to the data on one or more types of categories, based on a data designation operation received on a data reception screen for receiving the data designation operation, the data designation operation being for designating the one or more types of categories.

14. The point cloud processing apparatus of claim 1, wherein
the circuitry is further configured to identify the predetermined three-dimensional point cloud in the specific point cloud based on the labeled training data.

15. The point cloud processing apparatus of claim 2, wherein
the circuitry is further configured to identify the predetermined three-dimensional point cloud in the specific point cloud based on the data on the category.

16. The point cloud processing apparatus of claim 14, wherein
the circuitry is further configured to transmit, to an external apparatus, a result obtained by identifying the predetermined three-dimensional point cloud in the specific point cloud.

17. The point cloud processing apparatus of claim 14, wherein
the circuitry is further configured to display, on a display, a result obtained by identifying the predetermined three-dimensional point cloud in the specific point cloud.

18. A point cloud processing system, comprising:
the point cloud processing apparatus of claim 1; and
a terminal apparatus communicably connected to the point cloud processing apparatus,
the circuitry of the point cloud processing apparatus being further configured to transmit the determination result to the terminal apparatus,
the terminal apparatus including additional circuitry configured to:
receive the determination result transmitted from the point cloud processing apparatus; and
display, on a display, the determination result.

19. A point cloud processing system, comprising:
the point cloud processing apparatus of claim 2; and
a terminal apparatus communicably connected to the point cloud processing apparatus,
the circuitry of the point cloud processing apparatus being further configured to transmit a determination result to the terminal apparatus,
the terminal apparatus including additional circuitry configured to:
receive the determination result transmitted from the point cloud processing apparatus; and
display, on a display, the determination result.

20. A non-transitory recording medium storing a plurality of instructions which, when executed by one or more processors, causes the processors to perform a method, the method comprising:
identifying, based on labeled training data, a predetermined three-dimensional point cloud corresponding to the labeled training data in a target point cloud being a three-dimensional point cloud; and
determining whether a specific point cloud being a specific three-dimensional point cloud is included in a point cloud being another three-dimensional point cloud obtained by excluding the predetermined three-dimensional point cloud from the target point cloud.
